(19) United States
(12) Patent Application Publication
(10) Pub. No.: US 2002/0060498 A1
(43) Pub. Date: May 23, 2002

(54) Method and device for backup, and electronic device

(76) Inventors: Yasuyuki Higashiura, Kawasaki (JP); Takumi Kishino, Kawasaki (JP); Toshiaki Ibi, Kawasaki (JP); Takashi Ono, Kawasaki (JP); Shoki Kadowaki, Kawasaki (JP)

Correspondence Address: STAAS & HALSEY LLP, 700 11TH STREET, NW, SUITE 500, WASHINGTON, DC, 20001, US

(21) Appl. No.: 09/797,735

(22) Filed: Mar. 5, 2001

(30) Foreign Application Priority Data
Nov. 22, 2000 (JP) 2000-355844

(51) Int. Cl. H02J 9/00

(52) U.S. Cl. 307/64

(57) ABSTRACT

The memory backup device obtains power from four power supply systems having different voltages. These power supply systems are selectively employed based on their voltages. In operating, backup is performed by an internal battery as a first power supply system, or by power from a mainframe apparatus as a third or fourth power supply system. When the electronic device is to be stocked in a warehouse, only then, an external battery is connected as a second power supply system.

### FIELD OF THE INVENTION

The present invention relates to a device and method for holding an operation and the operating state of a circuit. Further, this invention relates to an electronic device that incorporates such a backup device.

### BACKGROUND OF THE INVENTION

In information processing devices and electronic devices, it is generally required to previously set data before the products are delivered out of the factory. In this case, the data is generally stored in a non-volatile memory.

By the way, in recent years, Internet service, electronic commerce and the like have been expanded, and thereby, a requirement for security increases. In order to meet the above requirement, a security data such as device individual ID and management information is used. Most of the aforesaid security data must be preset in forwarding from factories. Moreover, it is preferable that the security data is held in a non-volatile memory in view of data protection. This is effective in the following case. That is, in case of the non-volatile memory, when an abnormality is detected, the data stored in the non-volatile memory can be easily erased. In other words, secrecy of the data can be maintained. For this reason, backup is required for holding the data stored in the non-volatile memory.

In general, the aforesaid backup includes a backup battery, and backup is performed by a power of the backup battery. In this case, in order to keep long the backup battery, in fact, there are many cases where an AC power source and the backup battery are selectively used in accordance with the working condition. More specifically, in a state that the electronic device is connected to the AC power source, the backup is performed by a DC power generated from the AC power source. The backup battery is used only when the AC power source is turned off. For this reason, the backup battery is usually set so as to a capacitance of several percentages (%) of available period, and not 100%.

By the way, some times the electronic device is sold in the market soon after being manufactured. On the other hand, some times the electronic device is kept in a warehouse or the like for a long period. In the latter case, the backup is continuously performed by only backup battery. As described before, however, the capacitance of the backup battery is limited. Therefore, there is a possibility that data is erased resulting from a shortage of battery capacitance. In order to solve the above problem, the following three measure may be considered.

The first solving measure is as follows. On data is stored while delivering from factories. The backup battery is used only for protecting user's setting contents. In this case, the backup battery is connected when the operation of the electronic device is started.

The second solving measure is as follows. When required, the old backup battery is replaced with a new one.

The third solving measure is as follows. A battery having a large capacity is employed as the backup battery. A large capacity battery will last long.

However, the aforesaid measures have following disadvantages. When the first measure is employed, it is impossible to set a security data in delivering from factories. For this reason, there is a problem incapable of meeting the requirement described before.

When the second measure is employed, the housing of device needs to have a battery replaceable structure. In this case, when holding of the security data is considered, the battery replaceable housing is lack of protection to a mischief. Moreover, if the battery is removed from the housing by mistake, there is a possibility that the important data is lost.

When the third measure is employed, a backup battery having a large capacitance must be employed. As shown in FIG. 6, if the device lifetime (i.e., period where the device is normally operable) is assumed as being five years, the device may be kept in the warehouse for at least five years. Moreover, if the device lifetime (i.e., period where the production/selling of the device goes on as planned) is assumed as being five years, there is a possibility that the electronic device may be kept in the warehouse for about ten years. In usual use the battery consumption is very little. However, considering a period before operation after delivering from factories and a period where the electronic device is kept as a maintenance component, a battery having a capacitance usually required or more (see FIG. 6, ten years) will be required. Generally, the electronic devices are shipped soon after their manufacture. Only a few of the electronic devices may be kept in a warehouse for longer time. Thus, in all of manufactured electronic devices, it is wasteful to employ the backup battery having a large capacitance in preparation for the aforesaid purpose. In addition, if a battery having a large capacity is used, since the size of the battery increases as capacity increases, there is a drawback that the overall size of the electronic device increase, packaging limitation increases, and price of the device also increases.

### SUMMARY OF THE INVENTION

It is an object of this invention to provide a method and device for backup in which it is possible to achieve a size reduction, low pricing, and avoid wastefully usage of a battery. It is also an object of this invention to provide an electronic device including the backup device.

The backup device according to one aspect of this invention comprises a plurality of power supply units which supply a power obtained from different power sources to the target circuit. Each power supply unit is provided with a rank that represent a priority. A higher rank is provided when the priority is higher. Further, a control unit is provided. This control unit provides a control so as to connect a power supply unit to the target circuit, based on the rank provided to the power supply unit, from a power supply unit having a higher rank to a power supply unit having a lower rank.

The electronic device according to another aspect of this invention comprises a circuit device including a circuit having a predetermined function; and the backup device according to this invention.

The backup method according to still another aspect of this invention comprises the steps of: preparing a plurality of power sources; and preferentially supplying a power of either of the power sources to the circuit according to an independently determined order.

The electronic device according to still another aspect of this invention comprises a circuit device including a circuit having a predetermined function; a battery; a first backup device for supplying a power supplied from the battery to the circuit so as to keep an operation and/or state of the circuit; a second backup device for supplying a power supplied from an independently prepared power source to the circuit so as to keep an operation and/or state of the circuit; and a switch for selecting either of the first and second backup devices so that a power is supplied to the circuit from the selected backup device.

Other objects and features of this invention will become apparent from the following description with reference to the accompanying drawings.

### BRIEF DESCRIPTION OF THE DRAWINGS

FIG. 1 is a view schematically showing an internal configuration of an electronic device according to a first embodiment of the present invention;

FIG. 2 is a view showing a configuration of a memory backup device;

FIG. 3 is a view showing an appearance of the electronic device;

FIG. 4 is a view schematically showing an internal configuration of a memory backup device of an electronic device according to a second embodiment of the present invention;

FIG. 5 is a view showing an appearance of the electronic device according to the second embodiment of the present invention; and

FIG. 6 is a chart showing a relation between a device lifetime and a period stocked as a maintenance component.

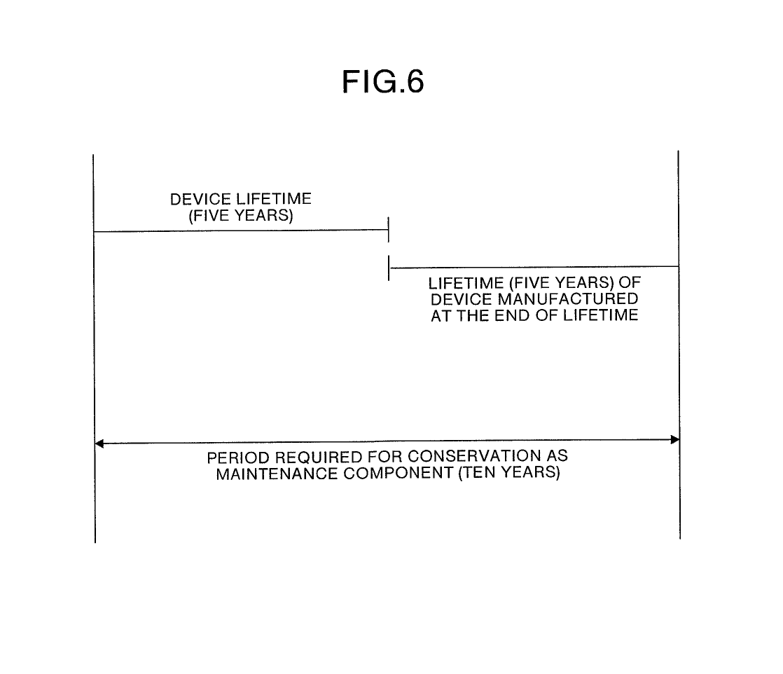

### DESCRIPTION OF THE PREFERRED EMBODIMENTS

Preferred embodiments of the method and device for backup and an electronic device according to the present invention will be detailedly described below with reference to the accompanying drawings. In this case, the present invention is not limited to the following embodiments.

The electronic device of this first embodiment has the following constituent features. More specifically, the electronic device includes a plurality of backup power supply systems, and uses these systems in accordance with voltages, condition or the like. By doing so, it is possible to achieve a reduction in a capacitance of backup internal battery, and to keep the electronic device as a maintenance component. The details will be described below.

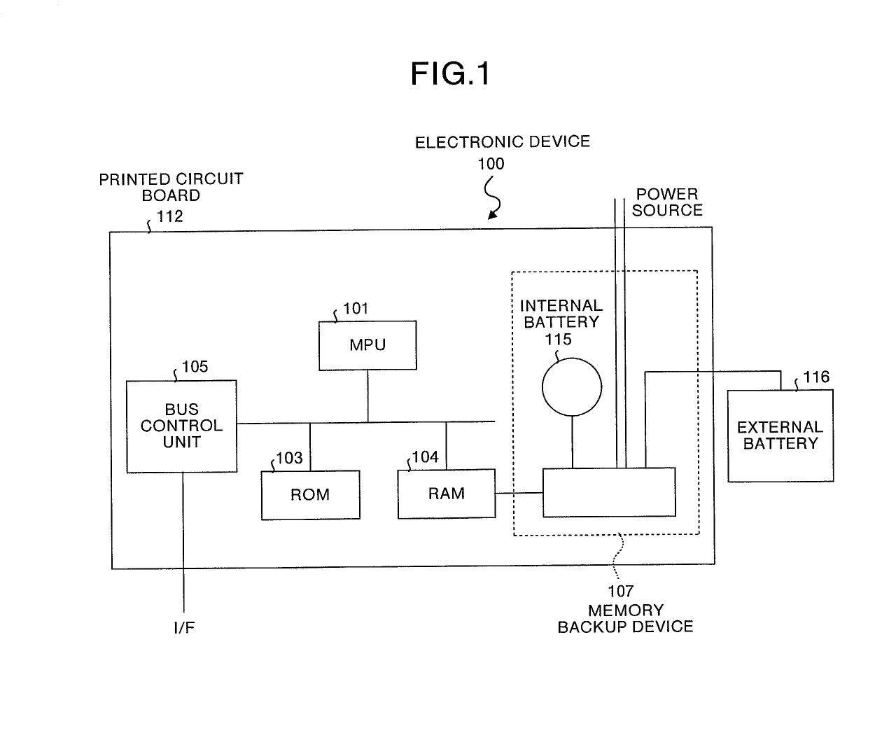

First, the outline of this electronic device 100 will be described with reference to FIG. 1. The electronic device 100 is mounted into another device (hereinafter, referred to as “mainframe apparatus”) such as a computer or the like, and is a so-called “card”, which is operated by a power supplied from the mainframe apparatus.

As shown in FIG. 1, the electronic device 100 includes an MPU 101, a ROM 103, a RAM 104, a bus control unit 105, and a printed wiring board 112. These components are interconnected via wiring patterns formed on the surface of the printed wiring board 112 and therein, and make a receipt and transmission of various data and signals each other or make an exchange with the mainframe apparatus, and thereby, perform their functions. Further, the electronic device 100 includes a memory backup device 107 for carrying out a backup of the RAM 104, and an internal battery 115 used as a backup power supply. Moreover, as the need arises, the electronic device 100 is connected with an external battery 116.

As described above, in this first embodiment, the memory backup device 107 for backing up the contents of the RAM 104 is constituent features. Therefore, mainly, the following is a description on the constituent features.

The RAM 104 is used for holding various information. In this first embodiment, considering a possibility that a security data is stored in the RAM 104, the RAM 104 is composed of a non-volatile memory. A predetermined information is written in the RAM 104 when the electronic device 100 is delivered from factories. For this reason, a power is always supplied to the RAM 104 via the memory backup device 107. As the RAM 104 of this first embodiment, the following RAM is used; more specifically, the RAM requires about 2V for backup, and about 3.3V for normal operation.

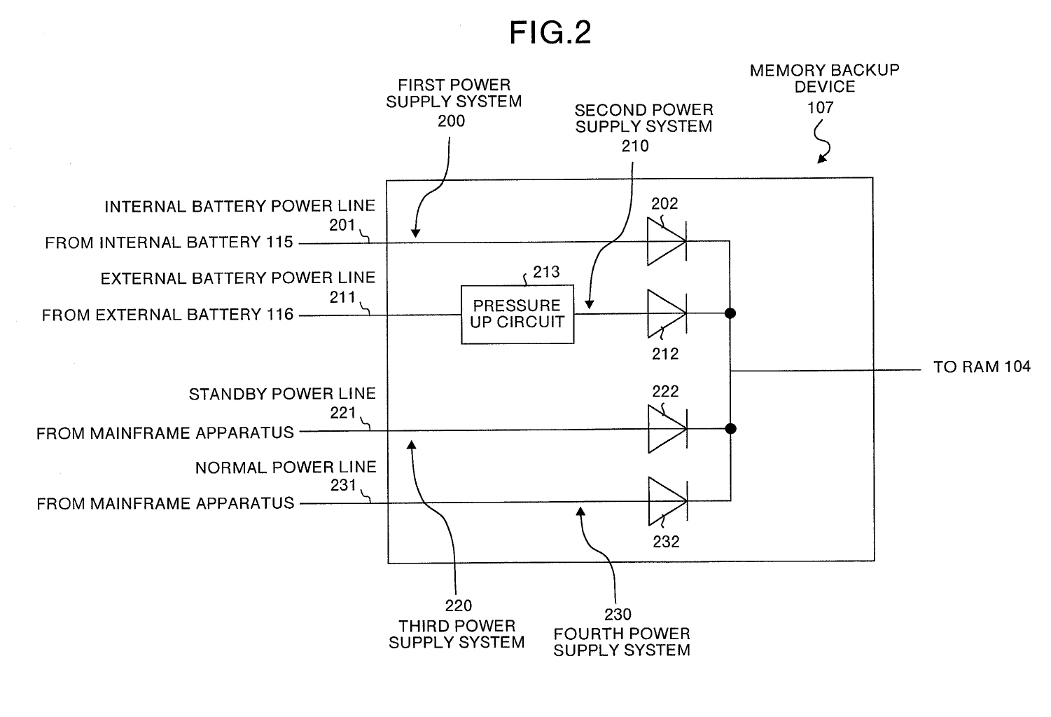

The memory backup device 107 is used for supplying a power for carrying out a backup for the RAM 104. As shown in FIG. 2, the memory backup device 107 includes four systems for supplying a power (i.e., a first power supply system 200, a second power supply system 210, a third power supply system 220, a fourth power supply system 230). Further, the memory backup device 107 uses these power supply systems in accordance with situation or the like.

Each power supply system is interconnected in parallel to the RAM 104. An order (ranking) is given to each power supply system depending upon a voltage supplied to the RAM 104. If power supply from each system is conflicting, according to the given ranking, a power is supplied to the RAM 104 from only any one of these systems. Thus, no power is supplied to the RAM 104 from other conflicting systems. In this first embodiment, ranking is given to the third power supply system 220, the second power supply system 210 and the first power supply system 200 in order. Moreover, the third power supply system 220 for carrying out a backup using a power supplied from the mainframe apparatus preferentially supplies a power. Conversely, the lowest ranking is given to the first power supply system 200 for carrying out a backup using a power of the internal battery 115. In this manner, the memory backup device 107 is constructed so as to keep a power of the internal battery 115 as much as possible.

In this case, the fourth power supply system 230 is not exactly used for backup, but is used for operating the RAM 104. For convenience of explanation, the fourth power supply system 230 will be described below.

The following is a description on each power supply system. The first power supply system 200 is used for maintaining (backup) a memory content of the RAM 104 by a power stored in the internal battery 115. The first power supply system 200 is prepared assuming the following situations. More specifically, when no power is supplied from the mainframe apparatus regardless of being connected thereto (e.g., service interruption state in operation), a period until operation start after manufacture, and further, when the electronic device is temporarily stored resulting from any factors.

The internal battery 115 is mounted into all electronic devices 100 in delivering from factories. As described later, in this electronic device 100, the internal battery 115 is non-exchangeable; for this reason, a power of the internal battery 115 must be set aside for later use as much as possible. Thus, a voltage supplied to the RAM 104 from the first power supply system 200 is set to the lowest value of four power supply systems. Therefore, only situation that power supply systems other than the first power supply system 200 cannot carry out backup, the first power supply system 200 carries out the backup.

More specifically, as shown in FIG. 2, the first power supply system 200 is constructed in a manner of supplying a power supplied from the internal battery 115 to the RAM 104 via an internal battery power line 201 provided on the printed wiring board 112 at unchanged voltage. Moreover, in order to prevent the internal battery 115 from being charged by a voltage of other power supply systems, the internal battery power line 201 is provided with a diode 202 on the midway thereof.

As described before, the case where the first power supply system 200 carries out backup is limited. Therefore, the internal battery 115 has a sufficient capacitance required for carrying out a backup for the RAM 104 only for a period of about three years. A lithium battery having about +3V is used as the internal battery 115.

The second power supply system 210 is used for maintaining (backup) a memory content of the RAM 104 by a power stored in the external battery 116. Further, the second power supply system 210 is prepared on the assumption that the electronic device 100 is used in a state that the electronic device is handled as a maintenance component (i.e., a state of being kept for a long period without being connected to the mainframe apparatus). In order to keep a power of the internal battery 115, backup for the RAM 104 must be carried out by the second power supply system 210 in a state that the electronic device is handled as a maintenance component. For this reason, the second power supply system 210 supplies a voltage (e.g., +3.5V) higher than the first power supply system 200 to the RAM 104.

More specifically, the second power supply system 210 includes a pressure up circuit 213 as shown in FIG. 2. Further, the second power supply system 210 is connected to a downstream side from the voltage step-up circuit 213 (RAM 104 side) in parallel with other power supply systems. Then, the voltage step-up circuit 213 steps up a power supplied from the external battery 116 via an external battery power line 211 provided on the printed wiring board 112 to a predetermined voltage (at least, a voltage higher than the first power supply system 200), and thereafter, the second power supply system 210 supplies it to the RAM 104. The voltage step-up circuit 213 performs a function for preventing a failure voltage from being applied to the external battery power line 211 from the outside.

Moreover, in order to protect the internal battery 115 and the external battery 116, the second power supply system 210 is provided with a diode 212 on the midway thereof. For example, a three-terminal regulator is usable as the voltage step-up circuit 213. However, a detailed configuration of the second power supply system 210 is not limited to the aforesaid configuration, and may be properly selected in accordance with a voltage required for backup.

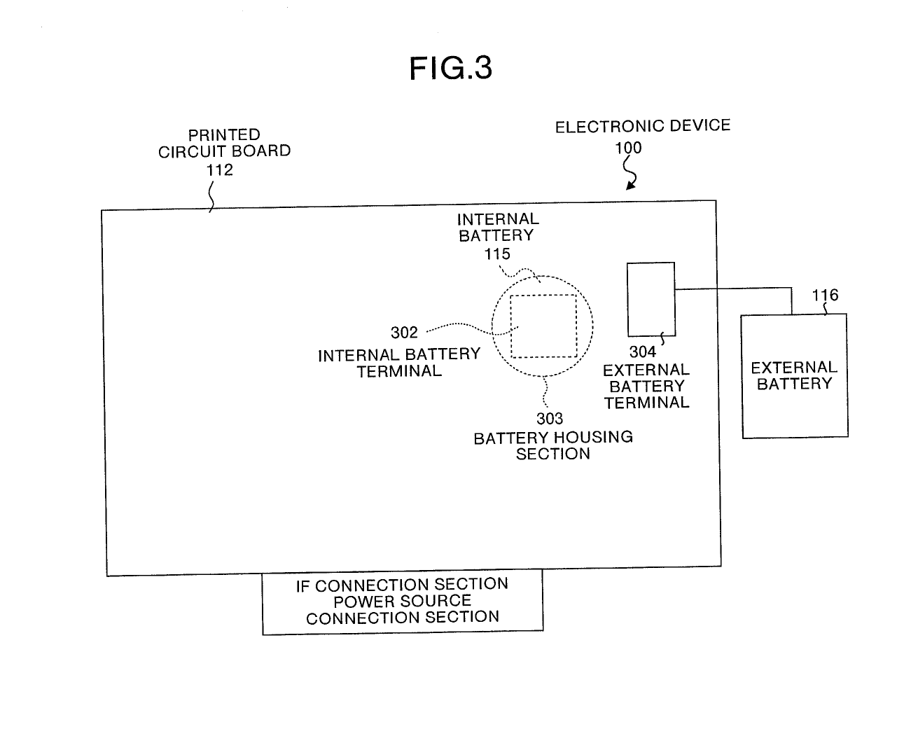

The external battery 116 is not mounted into all electronic devices 100. The external battery 116 is mounted to only electronic devices, which are kept as a maintenance component for a long period, in order to use the second power supply system 210. For this reason, the second power supply system 210 is provided with an external battery terminal 304 (see FIG. 3) for mounting the external battery 116. The external battery terminal 304 is provided in a state of being exposed from the outside, or in a state capable of making an access from the outside at least (for example, the state which the openable/shutable lid is covered). A lithium battery is used as the external battery 116, and has a sufficient capacitance required for a period where the electronic device 100 is kept as a maintenance component. In fact, a plurality of lithium batteries may be bundled, and thereby, a large capacitance is realized. In FIG. 3, legend 302 represents an internal battery terminal, legend 303 represents a battery housing section, and legend 305 represents an IF connection section power source connection section.

The third power supply system 220 is used for maintaining (backup) a memory content of the RAM 104 by a direct current power supplied from a power supply unit of the mainframe apparatus. The third power supply system 220 is prepared on the assumption that the electronic device 100 is used in a state that the mainframe apparatus is not operated (off state in operation) although it is mounted into the mainframe apparatus. In order to keep a power of the internal battery 115, in an off state in operation, the third power supply system 220 must carry out a backup for the RAM 104. For this reason, the third power supply system 220 supplies a voltage (e.g., +3.3 V) higher than the first power supply system 200 to the RAM 104.

More specifically, as shown in FIG. 2, the third power supply system 220 is constructed in a manner of intactly supplying a power supplied from a power supply unit of the mainframe apparatus to the RAM 104 via a stand-by power line 221 provided on the printed wiring board 112. However, in this case, it is set forth as a premise such that the power supply unit of the mainframe apparatus is constructed so that a power having a predetermined voltage (+3.3 V in this case) can be supplied regardless of the operating state (on/off) of the mainframe apparatus itself. The power supplied from the mainframe apparatus results from a power supply (in general, commercial AC power supply) connected to the mainframe apparatus. Further, the third power supply system 220 is provided with a diode 222 on the midway thereof.

The fourth power supply system 230 is used for operating the RAM 104 by a direct current power supplied from the power supply unit of the mainframe apparatus. As described before, strictly speaking, the fourth power supply system 230 is not a power supply system for backup. Namely, the fourth power supply system 230 is prepared for supplying a power required for normal operation (data read, write) to the RAM 104 in a state that the electronic device 100 is mounted to the mainframe apparatus and the mainframe apparatus is operated (on state in operation). A voltage of power supplied from the fourth power supply system 230 is set to +3.3V.

More specifically, as shown in FIG. 2, the fourth power supply system 230 is constructed in a manner of intactly supplying a power having a predetermined voltage (+3.3V in this case) supplied from a power supply unit of the mainframe apparatus to the RAM 104 via a normal power line 231 provided on the printed wiring board 112. Moreover, the power supply to the RAM 104 must be continuously made without an instantaneous break when it transfers from a normal operating state to a backup state. For this reason, the fourth power supply system 230 is connected in parallel with other power supply systems 200 to 220 for backup.

Further, the fourth power supply system 230 is provided with a diode 232 on the midway thereof.

In this first embodiment, a “power supply unit” described in claims of this invention is equivalent to the power supply systems 200, 210 and 220 (in particular, the internal battery power line 201, the external battery power line 211 or the like). A “control unit” is realized by conducting paths (see FIG. 2) interconnecting the voltage step-up circuit 213, the power supply systems 200, 210 and 220 (in particular, the internal battery power line 201, the external battery power line 211 or the like) in parallel with each other. A“supply voltage” means a voltage supplied from each power supply system to the RAM 104; for example, a voltage from the first power supply system 200 is equivalent to +3V, and a voltage from the second power supply system 210 is equivalent to +3.5V. A “voltage converter circuit” is equivalent to the voltage step-up circuit 213. A “parallel connection unit” is equivalent to the conducting paths (see FIG. 2) interconnecting the power supply systems 200, 210 and the like (in particular, the internal battery power line 201, the external battery power line 211 or the like) in parallel with each other. A “circuit”, which is a backup object, is equivalent to the RAM 104. A “first power supply unit” is equivalent to the first power supply system 200. A “battery” used as a power source of the first power supply unit is equivalent to the internal battery 115. A “power supply terminal” is equivalent to the external battery terminal 304 with respect to the second power supply system 210, for example.

Next, the following is a description on an operation of the electronic device 100. In manufacturing, the electronic device 100 is connected with the internal battery 115 so that various security data is stored in the RAM 104, and thereafter, is delivered from factories. In a state that the electronic device 100 is delivered from factories, backup is performed by the first power supply system 200 (i.e., internal battery 115).

Most of manufactured electronic devices 100 are intactly delivered from factories, and then, are mounted to the mainframe apparatus, and thereafter, are operated. In this state, backup of the RAM 104 is carried out by a power supplied from the mainframe apparatus. More specifically, when a power of the mainframe apparatus is turned off, the backup for the RAM 104 is performed by the third power supply system 220. Moreover, when the power is turned on, the backup for the RAM 104 is performed by the fourth power supply system 230. Occasionally, there is the case where the power supply from the mainframe apparatus is stopped by service interruption. In such a case, the first power supply system 200 performs a backup for the RAM 104 by using a power of the internal battery 115.

On the other hand, part of delivered electronic devices 100 is stocked as a maintenance component in a warehouse or the like for a long period. When the electronic device 100 is stocked as described above, the external battery 116 is connected to the electronic device 100. In the second power supply system 210, the voltage step-up circuit 213 steps a voltage of the external battery 116 up to a voltage (e.g., +3.5 V) higher than that supplied by the first power supply system 200. Therefore, for the duration that the electronic device 100 is stocked, the second power supply system 210 carries out a backup for the RAM 104 by using a power of the external battery 116. Accordingly, a power of the internal battery 115 is intactly kept without being used for the backup. In this case, the external battery 116 having a sufficient capacitance is employed on the assumption that the electronic device 100 is stocked for a long period; therefore, there is no possibility that a security data is lost due to a shortage of power during a conservation of the electronic device 100.

The electronic device 100 thus conserved is delivered in order to use it as a maintenance component as the need arises. When the electronic device 100 is delivered as described above, the external battery 116 is detached from the electronic device 100. The external battery 116 is detached from the electronic device 100, and thereafter, no backup is performed by any of the second, third and fourth power supply systems 210, 220 and 230 until the electronic device 100 is mounted to the mainframe apparatus, and is operated. Therefore, for the duration, the backup is performed by the first power supply system 200. However, in general, the aforesaid duration is short.

Moreover, the internal battery 115 is not used for backup during a conservation of the electronic device 100 in a warehouse or the like; therefore, a sufficient power is kept in the internal battery 115. Accordingly, even when the electronic device 100 is stocked in a warehouse for a long period, the internal battery 115 sufficiently functions as a backup power supply until a device lifetime of the electronic device 100 becomes dead. As a result, there is no case where the data stored in the RAM 104 is lost due to a shortage of power of the internal battery 115. In addition, the external battery 116 may be detached from the electronic device 100 just before a user starts to operate it, and not detached there from in delivering. In this case, the electronic device 100 is delivered in a state that the external battery 116 is connected thereto. By doing so, a power of the internal battery 115 is further kept.

Each power supply system is used according to ranking given based on a difference between voltages supplied by individual systems. Moreover, even if each power supply system is in a state of being not substantially used for backup, in a state that each system is capable of functioning (e.g., a state that the second power supply system 210 is connected with the external battery 116), each power supply system keeps a state of applying a voltage to a circuit. Therefore, even when the power supply system performed backup so far does not perform its function, a power supply from other power supply systems is immediately started. As a result, a power supply to the RAM 104 is performed without being instantaneously interrupted. Therefore, there is no case where the data is lost due to switch the power supply system. Further, it is possible to securely and safely carry out a work such that a worker manually connects the external battery 116 to the electronic device and detaches from there.

As described above, according to this first embodiment, there is no need of employing a battery having a large capacitance exceeding a capacitance required for a normal operation as the backup internal battery 115. Therefore, it is possible to achieve a cost reduction without wastefully using an internal space of the electronic device 100. On the other hand, when the electronic device 100 is stocked as a maintenance component, the external battery 116 having a sufficiently large capacitance is connected, and thereby, the electronic device 100 is durable to a conservation of along period. The above external battery 116 having a large capacitance is used for only electronic device stocked as a maintenance component; therefore, the battery is not wastefully used. Therefore, it is possible to reduce a price of device without losing a reliability. Moreover, there is no need of receiving the above external battery having a large capacitance; therefore, an internal space of the electronic device 100 can be used without wastefulness. As a result, the electronic device 100 can be miniaturized. In addition, this miniaturization of the electronic device 100 contributes to miniaturization of a mainframe apparatus into which the electronic device 100 is mounted.

The electronic device 100 is excellent in saving a security data. More specifically, the electronic device 100 is delivered from factories in a state that the internal battery 115 is built therein; therefore, it is possible to deliver the electronic device 100 from factories in a state that a security data is written into the RAM 104.

The backup object is not limited to memory. Of course, various circuits, for example, a RTC (Real Time Clock) operation and state may be held.

In this first embodiment, the internal battery 115 has been constructed so that it is not replaced with another battery in view of security data protection. However, when there is no need of considering the above security data, the internal battery 115 may be exchanged.

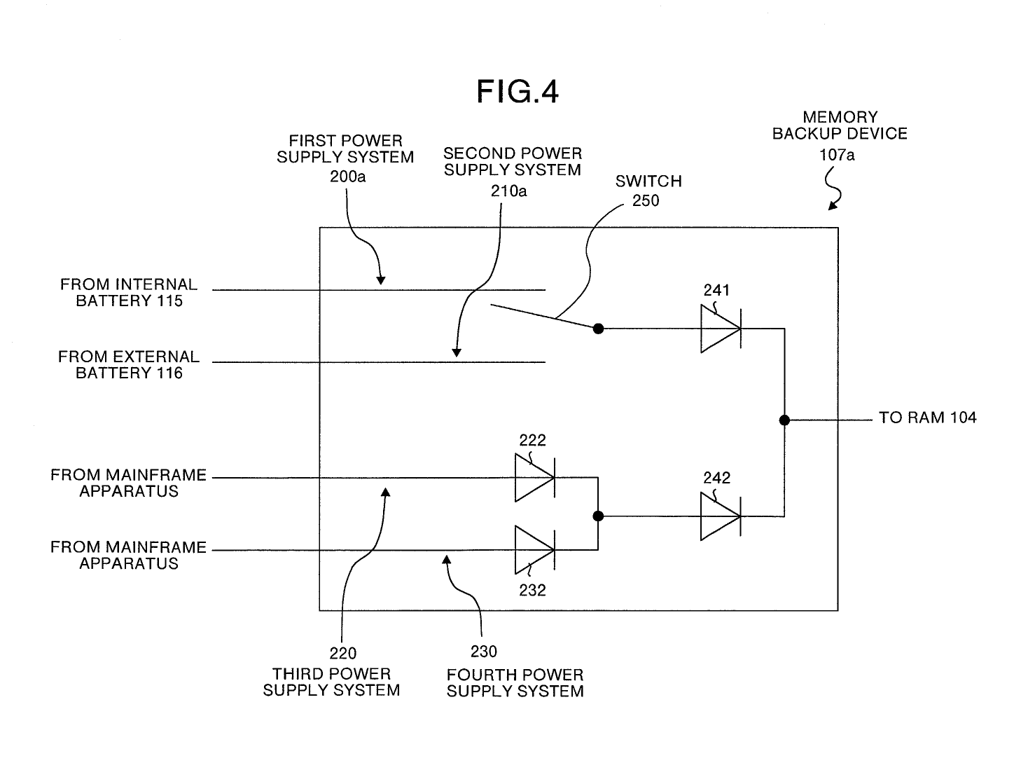

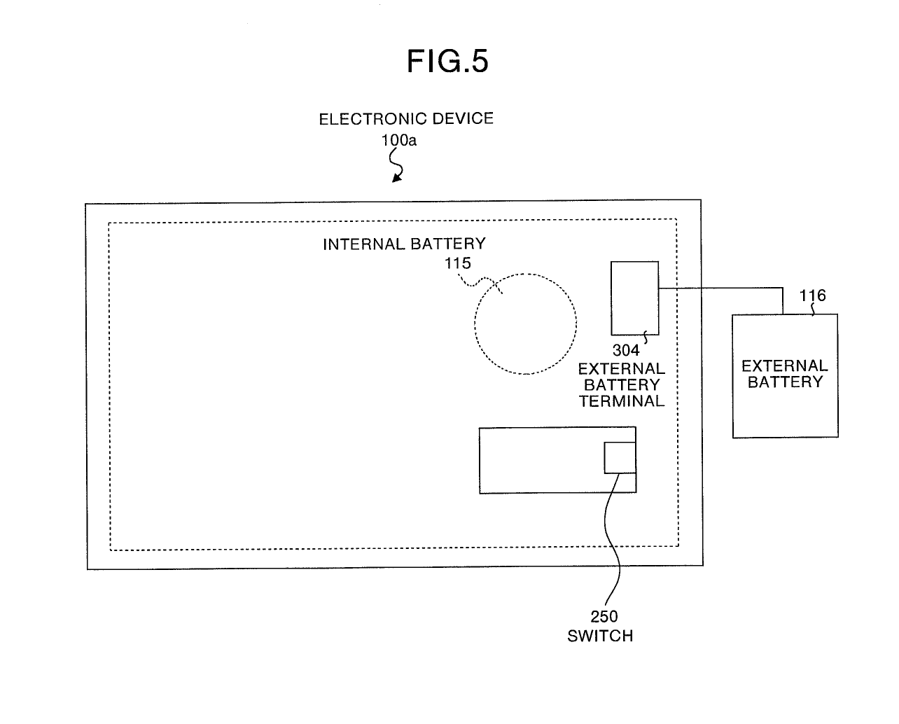

An electronic device 100a of this second embodiment is different from the above first embodiment in that the power supply system is changed over by a switch. The electronic device 107a of this second embodiment will be detailedly described below. A configuration of a memory backup device 107a of this second embodiment will be described with reference to FIG. 4 and FIG. 5. In these figures, like reference numerals are used to designate parts having the same function as the first embodiment, and the details are omitted.

In this second embodiment, the memory backup device 107a includes a switch 250 for changing over a first power supply system 200a and a second power supply system 210a. The switch 250 has an operating part exposed outside the external battery terminal 304, as shown in FIG. 5, and is constructed in a manner that a worker manually operates the switch. The first power supply system 200a and the second power supply system 210a have no need of supplying a voltage different from each other. Therefore, in this second embodiment, the second power supply system 210a includes no voltage step-up circuit 213. Moreover, the first power supply system 200a and the second power supply system 210a are fully separated from other power supply systems by the switch 250 in unnecessary case; for this reason, these first and second power supply systems 200a and 210a include no diodes 202 and 212, respectively.

In this embodiment, a “first backup device” described in claims of this invention is equivalent to the first power supply system 200a. Further, a “second backup device” described in claims of this invention is equivalent to the second power supply system 210a. Furthermore, a “switch” is equivalent to the switch 250.

Next, the following is a description on an operation of the electronic device 100a. The ranking of each power supply system is similar to the first embodiment. In this case, an operation of the switch 250 different from the first embodiment will be mainly described below.

In this second embodiment, in order to make a changeover of the first power supply system 200a and the second power supply system 210a, the switch 250 is used. For this reason, the following problem arises; more specifically, there is a possibility that no power is supplied to the RAM 104 when changing over these power supply systems. In order to solve the above problem, the operation of the switch 250 must be carried out under the condition that a third power supply system 220 or fourth power supply system 230 can function. More specifically, the procedure for operating the switch 250 is as follows.

After manufactured, factory delivery inspection is carried out with respect to the electronic device 100a. After the delivery inspection is completed, the switch 250 selects the internal battery 115. In this state, information such as individual ID, cryptographic key or the like are written into the RAM 104.

Some of the electronic devices 100a used for operation are intactly delivered from factories (when the electronic device 100a is not stocked as a maintenance component). As the case may be, the electronic device 100a is delivered together with the mainframe apparatus in a state of being mounted therein.

On the other hand, in the case of being stocked as a maintenance component in a warehouse or the like, the electronic device 100a is temporarily mounted on the mainframe apparatus connected to an AC power source. More specifically, a state is made such that the third power supply system 220 or fourth power supply system 230 can function. Moreover, the external battery 116 is connected so that the second power supply system 210a can function. In this state, the switch 250 is operated so as to select the external battery 116. In this case, the maintenance component (i.e., electronic device 100a) is delivered from a warehouse in a state of being connected to the external battery 116.

When an operating electronic device 100a fails, it is replaced with another maintenance component. In this case, first, the electronic device 100a having a failure is removed from the mainframe apparatus, and then, a new electronic device 100a prepared as a maintenance component is mounted onto the mainframe apparatus. Thereafter, the switch 250 is operated so as to select the internal battery 115. Finally, the external battery 116 is removed from the electronic device 100a. In the manner as described above, a replacement work is completed.

As described above, in this second embodiment, it is possible to use a battery without wastefully consuming a power of battery, like the above first embodiment. Further, the electronic device can be made into a small size, and a cost reduction can be achieved. Furthermore, in place of the voltage step-up circuit 213, a cheap switch 250 is used; therefore, a device cost can be reduced. However, in this case, as described in the above operating explanation, there is a need of giving attention to the manual operation of the switch 250.

In the above second embodiment, the switch 250 has been directly operated by manual. However, in this case, the operating construction is not limited to the manual operation. For example, the switch 250 may be operated in a non-contact state by a magnetic force or the like. According to the construction, there is no need of providing an operating part of the switch 250 in a state that the operating part is exposed outside the external battery terminal 304; therefore, this construction is excellent in security.

As is evident from the above description, according to the present invention, in the backup device, the backup method and the electronic device, it is possible to eeffectively use a battery, which is a backup power source without wastefully consuming a power of the battery. Moreover, the electronic device can be miniaturized, and a cost reduction can be achieved. The details are as follows.

In the invention described in the first aspect, a power supply to circuit is preferentially carried out by a high rank power supply unit (i.e., power source). Therefore, when a battery is used as a power source, it is possible to estimate which battery is consumed earliest. Moreover, ranking is set as desired, and thereby, a desired battery is preferentially used for carrying out a backup. Conversely, the desired battery can be kept. A consumption of power source is accurately estimated; therefore, it is possible to prevent an unexpected accident such shortage of power or the like, and to securely perform a backup.

Further, in the invention described in the second aspect, the power supply units actually supplying a power to circuit are automatically changed over on the basis of their voltage; therefore, a special operation is unnecessary. As a result, there is no margin of making an operational mistake or the like. Moreover, the backup device includes a voltage converter circuit; therefore, there is almost no limitation to power source (in particular, limitation to voltage); as a result, an arbitrary power source is usable.

Further, in the invention described in the third aspect, the backup device uses a plurality of power supply units in accordance with the needs; therefore, it is possible to securely keep a circuit operation and/or state under various situations. Moreover, the power supply units are automatically changed over; therefore, a special operation is unnecessary. In other words, there is no margin of making an operational mistake or the like. In addition, in the configuration including a voltage converter circuit, there is almost no limitation to power source.

Further, in the invention described in the fourth aspect, a power supply to circuit is preferentially carried out by a high ranking power source. Therefore, when a battery is used as a power source, it is possible to estimate which battery is consumed earliest. Moreover, ranking is set as desired, and thereby, it is possible to preferentially consume a desired battery. Conversely, the desired battery can be kept for preparation. A consumption of power source is accurately estimated; therefore, it is possible to prevent unexpected accidents such as shortage of power or the like, and thus, to securely perform a backup.

Further, in the invention described in the fifth aspect, a plurality of power supply units is used while being changed over by a switch. Therefore, it is possible to make small a capacitance of battery built in the electronic device itself. Moreover, a power of the battery can be kept as much as possible.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A backup device, which supplies a power obtained from a power source to a target circuit so as to maintain operation and/or state of said target circuit, said backup device comprising:
a plurality of power supply units which supply a power obtained from different power source to the circuit, each power supply unit being provided with a priority order; and
a control unit which provides a control so as to provide a power to said target circuit from a power supply unit having provided with a higher priority order.

2. The backup device according to claim 1, wherein said control unit includes,
a voltage converter circuit provided with at least one power supply unit, and converts a voltage obtained from said power source of the corresponding power supply unit in such a manner that the output voltage has a magnitude that is equivalent to the priority order of that power supply unit; and
a parallel connection unit provided on a downstream side from said voltage converter circuit so as to interconnect said power supply units in parallel with each other.

3. An electronic device comprising:
a circuit device including a circuit having a predetermined function; and a backup device which supplies a power obtained from a power source to a target circuit so as to maintain operation and/or state of said target circuit,
said backup device including,
a plurality of power supply units which supply a power obtained from different power source to the circuit, each power supply unit being provided with a priority order; and
a control unit which provides a control so as to provide a power to said target circuit from a power supply unit having provided with a higher priority order.

4. A backup method of supplying a power obtained from a power source to a target circuit so as to maintain operation and/or state of said target circuit, the method comprising the steps of:
preparing a plurality of power sources; and
preferentially supplying a power of either of said power sources to said target circuit according to an independently determined order.

5. An electronic device comprising:
a circuit device including a circuit having a predetermined function;
a battery;
a first backup device which supplies a power supplied from said battery to said circuit so as to maintain an operation and/or state of said circuit;
a second backup device for supplies a power supplied from an independently prepared power source to said circuit so as to maintain an operation and/or state of said circuit; and
a switch for selecting either said first or second backup device as a backup device for supplying power to said circuit.
